(19) United States
(12) Patent Application Publication
(10) Pub. No.: US 2022/0077515 A1
(43) Pub. Date: Mar. 10, 2022

(54) SYSTEM TO IMPROVE SAFETY AND RELIABILITY OF A LITHIUM-ION (LI-ION) BATTERY PACK

(71) Applicant: KONINKLIJKE PHILIPS N.V., EINDHOVEN (NL)

(72) Inventors: EVGENIY LEYVI, ARLINGTON, VA (US); VIJAYA KUMAR AIYAWAR, CHESTER, NH (US); MELINDA ZHAO, ACTON, MA (US); JOE DEMORE, ANDOVER, MA (US); JACK JIANHONG GUO, ANDOVER, MA (US); RAHUL SINGH, ANDOVER, MA (US); UDAY REDDY, PUNE, IN (US)

(21) Appl. No.: 17/413,243

(22) PCT Filed: Dec. 13, 2019
(86) PCT No.: PCT/EP2019/085196

§ 371 Date: Jun. 11, 2021

Related U.S. Application Data
(60) Provisional application No. 62/779,518, filed on Dec. 14, 2018.

(51) Int. Cl. H01M 10/48; H01M 50/579; H01M 50/581

(52) U.S. Cl. CPC H01M 10/482; H01M 10/486; H01M 2200/103; H01M 50/581; H01M 50/579

(57) ABSTRACT

A battery pack (12) includes one or more electrical battery cells (18). A battery management system (20) includes at least one electronic processor (24) configured to monitor parameters of the battery pack. At least one fault detection sensor includes at least one of: at least one gas sensor (36) configured to measure a gas evolving from the plurality of electrical battery cells; and a shock sensor (30) configured to measure an impact on the battery pack. A housing (16) encloses the plurality of electrical battery cells, the battery management system, and the at least one fault detection sensor. The battery management system is configured to perform a remediation action responsive to detection of a fault by the at least one fault detection sensor.

### FIELD

The following relates generally to the battery cells arts and more particularly to the battery cell monitoring arts, the battery cell safety arts, the battery cell remediation arts, and to related arts.

### BACKGROUND

Many class II and III medical devices (e.g., patient monitors, mechanical ventilators and cardiac defibrillators) rely on battery power when in operation and not connected to AC electrical power. Battery packs in these devices are typically made of re-chargeable lithium ion (Li-ion) photovoltaic cells and are monitored by an on-board Battery Management System (BMS), which is in constant communication with the host device about a state of the battery during operation.

While Li-ion cells excel in electrical capacity, high energy density and long-life cycle, they are susceptible to damage caused by electrical, thermal and/or mechanical abuse. Deviations from the recommended charge/discharge guidelines or mishandling of the batteries may result in damage to the cells and eventually lead to the phenomenon called “thermal run-away” (TRA). In general, TRA is a combination of chemical and electrical events inside the cell in response to electrical, mechanical or thermal abuse and leading to the cell's temperature rise, overheating and eventually ending in release of toxic gases, fire or explosion.

Such medical devices are often deployed outside of clinics and hospitals, for example in ambulances, helicopters, or other medical transport, and in such settings are particularly subject to vibrations and mechanical shocks during operation. In addition, batteries may experience temperature and mechanical extremes during shipment.

It is also possible that when not in use a battery pack may be connected to a non-original equipment manufacturer (OEM) external charger (e.g., outside the host medical device), whose operation does not fully conform to the cells' manufacturer charge guidelines.

Commercial Li-ion cells sometimes include safety features like internal pressure, temperature, and current (PTC) switches, tear away tabs, shutdown separators, insulators, headers, and vent ports on battery packs, and manufacturers publish guidelines on charge/discharge conditions, which the medical equipment designers and users of the battery packs must follow. BMS controllers add another layer of safety by managing charge/discharge of cells, monitoring of cells' critical electrical operating parameters, and shutting down the battery if electrical operating conditions are violated.

The following discloses a new and improved systems and methods.

### SUMMARY

In one disclosed aspect, a battery pack includes one or more electrical battery cells. A battery management system includes at least one electronic processor configured to monitor parameters of the battery pack. At least one fault detection sensor includes at least one of: at least one gas sensor configured to measure a gas evolving from the plurality of electrical battery cells; and a shock sensor configured to measure an impact on the battery pack. A housing encloses the plurality of electrical battery cells, the battery management system, and the at least one fault detection sensor. The battery management system is configured to perform a remediation action responsive to detection of a fault by the at least one fault detection sensor.

In another disclosed aspect, a battery pack includes a plurality of electrical battery cells. A battery management system includes at least one electronic processor configured to monitor parameters of the plurality of battery cells. A shock sensor is configured to detect a fault comprising an impact to the battery pack. A housing encloses the plurality of electrical battery cells, the battery management system, and the shock sensor. The battery management system is configured to perform a remediation action responsive to detection of a fault by the shock sensor.

In another disclosed aspect, a battery pack includes a plurality of electrical battery cells. A battery management system includes at least one electronic processor configured to monitor parameters of the plurality of battery cells. At least one gas sensor is configured to detect a fault comprising a gas evolving from the plurality of battery cells. A housing encloses the plurality of electrical battery cells, the battery management system, and the at least one gas sensor. The battery management system is configured to perform a remediation action responsive to detection of a fault by the at least one gas sensor.

One advantage resides in providing a battery management system to detect gas generation by battery cells.

Another advantage resides in providing a battery management system to detect an impact to a battery pack.

Another advantage resides in providing battery management system to generate a remedial action upon detection of gas and/or an impact to a battery pack.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates a battery pack according to one aspect; and

FIG. 2 shows exemplary flow chart operations of the battery pack of FIG. 1.

### DETAILED DESCRIPTION

Existing Li-ion cells used in battery packs to power medical devices have safety features including internal pressure, temperature, and current (PTC) switches, tear-away tabs, shutdown separators, vent ports, and so forth. However, in spite of these measures, fire and explosion incidents have occurred in connection with medical devices powered by Li-ion batteries. The failure sequence leading to such events can in some instances be sufficiently rapid that existing safety devices are unable to react fast enough to prevent catastrophic failure.

The following discloses adding shock sensors and/or gas sensors to detect an underlying cause of a failure (e.g., shock impact or incipient gas release, respectively) in conjunction with an on-board Battery Management System (BMS) that is programmed to take remediation prior to occurrence of a catastrophic event. In the case of an urgent event such as a detected gas leak which has a high likelihood of rapidly resulting in fire or explosion, the BMS responds directly, e.g. by operating a fuse to disable the battery pack and prevent a failure. The sensor data may also be stored in an on-board memory and read off when the battery is next connected with a medical device capable of reading and processing the stored sensor data. This may be an appropriate remediation in the case of low-energy impact event detections, which have low likelihood of causing imminent catastrophic damage. If the battery is currently installed in such a medical device, then sensor data transfer and processing can occur immediately. In another (not necessarily mutually exclusive) variant, the Li-ion battery pack includes a wireless transceiver (e.g. Bluetooth and/or Wi-Fi) via which the Li-ion battery transmits the sensor data to a battery management center at a hospital, along with the battery pack serial number or other unique identifier.

In some embodiments, the shock sensors are entirely passive, and thereby do not draw electrical power from the battery except when an impact event is detected. Some contemplated shock sensors comprise open circuit elements with spring contacts that vibrate to make electrical contact upon undergoing a sufficient impact. In one embodiment, several such passive shock sensors are provided with different spring stiffness levels, and the magnitude of the shock is determined by which of these shock sensor(s) is triggered. In another embodiment, a single spring-based shock sensor is operatively connected with a “wakeup” pin of an active accelerometer, so that the shock sensor operates to wake up the accelerometer, which rapidly measures the magnitude of the shock. Again, electrical power consumption is minimized as the active accelerometer is in a sleep state or other low power state unless/until activated by the spring-based shock sensor.

The gas sensors are designed to measure a gas that is typically evolved from a compromised Li-ion battery cell. Suitable gases for detection include hydrogen, benzene, methane, or some other flammable gas. To conserve power and enhance sensitivity, placement of the gas sensor(s) is chosen to provide efficient gas detection. Each Li-ion battery cell usually has a vent near the positive terminal, so a gas sensor could be placed to sniff the vent of each battery cell, thereby providing comprehensive detection of gas leakage from any of the cells. To reduce the number of gas sensors, a single gas sensor could instead be placed at a vent of the battery pack housing.

Remediation can take various forms depending upon the nature and magnitude of the sensor data, as well as the type of medical device. For class II medical devices which can be safely shut off, the on-board battery management system of the battery pack can shut off the battery if the detected shock and/or gas leakage magnitude is above a threshold. On the other hand, if the shock is of a lower value then this may be simply recorded, and an advisory may be displayed on the medical device display indicating that the battery should be replaced. If a sufficient number of small shocks are detected, then the battery may shut down, or alternatively an advisory may be displayed indicating the battery should be replaced. In the case of a detected gas leak in a battery powering a class II medical device, it is likely that battery shutdown will be the appropriate remediation.

For class III medical devices performing a life-critical function, abrupt battery shutdown may not be an option as the device must continue operating. In this case, a critical alert (visual and possibly audible) is suitably presented informing medical personnel of imminent battery failure so that immediate action (e.g. bringing in a replacement medical device) can be taken.

Typically, the battery pack includes a plurality of electrical battery cells, e.g. electrically interconnected in series to provide higher voltage, or in parallel to provide higher current/capacity. However, a battery pack with as few as a single electrical battery cell is also contemplated. While Li-ion battery packs employing Li-ion electrical battery cells are the current standard in the medical field, it is contemplated to employ the disclosed concepts with other types of batteries, such as lithium polymer (LiPo) electrical battery cells, or nickel-metal hydride (NiMH) electrical battery cells. The gas sensor(s) should be chosen to detect a gas that is evolved during malfunction of the particular type of battery cell(s) in use.

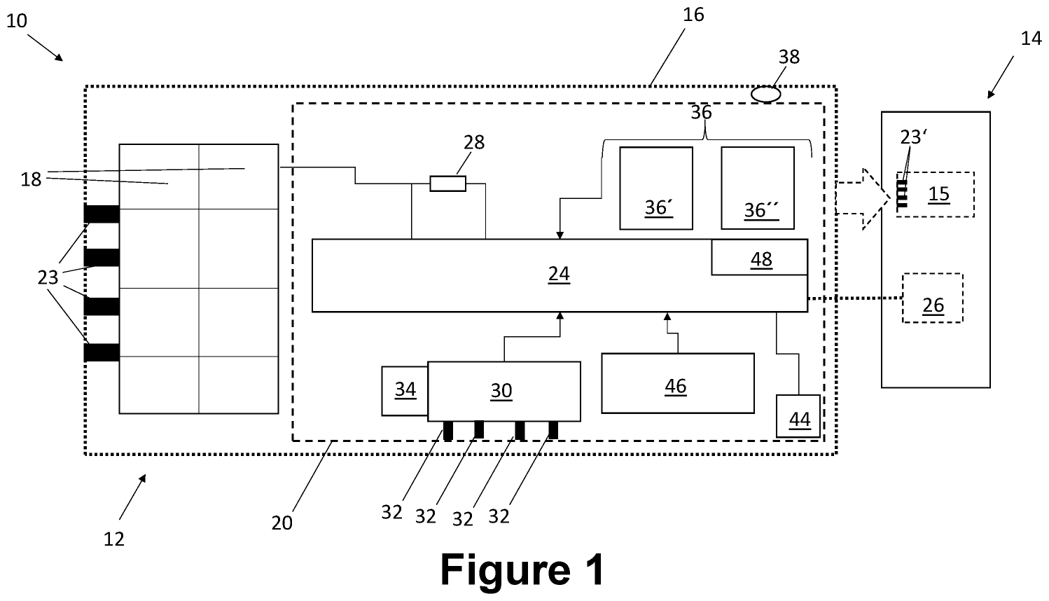

With reference to FIG. 1, an apparatus 10 showing a battery pack 12 connected with a medical device 14, for example by being inserted into a battery receptacle 15 of the medical device 14, to electrically power the medical device. The battery pack 12 includes a housing 16 enclosing various components of the battery pack. A plurality of electrical battery cells 18 is connected to a battery management system 20. The battery management system 20 includes at least one electronic processor 24 which is configured to monitor parameters of the battery cells 18. The at least one electronic processor (e.g. a microprocessor or microcontroller and ancillary circuitry not shown in FIG. 1) implements a set of programmable voltage, current, capacity, and temperature registers, whose values are programmed according to cells' manufacturer's recommendations to ensure safe and reliable charge/discharge cycles of the battery pack. In use, the battery pack 12 is inserted into the battery receptacle 15 of the medical device 14. In a typical arrangement, the shape and size of the housing 16 of the battery pack 12 is designed to fit snugly into the battery receptacle 15 with contacts 23 of the battery pack 12 placed into contact with mating contacts 23′ of the battery receptacle 15 to conduct electrical power (e.g. electrical voltage at a designed electrical current) from the battery pack 12 (and more particularly from the electrical battery cells 18) to electrically power the medical device 14. In general, the paired contacts 23, 23′ provide for conveying electrical power from the battery pack 12 to the medical device 14, and optionally also include paired contacts for conveying data, for example using an industry-standard System Management Bus (SMBus) protocol. Although not shown in FIG. 1, it is to be understood that the battery cells 18 are electrically interconnected in electrical series, electrical parallel, or some parallel-series interconnect configuration, to deliver electrical power. (In a limiting case, there may be a single electrical battery cell 18, in which case such interconnection of multiple cells is not employed). The battery receptacle 15 may be optionally designed with a hinged cover, slide-off cover, or the like to limit inadvertent contact with the installed battery pack; alternatively, a portion of the housing 16 of the battery pack 12 may be flush with a housing of the medical device 14, or a portion of the housing 16 of the battery pack 12 may extend outside of the battery compartment 15.

The at least one electronic processor 24 is configured to communicate with a microprocessor 26 of the medical device 14 by way of paired data contacts of the set of contacts 23, 23′ conveying information between the two processors 24, 26 via the SMBus protocol when the battery pack 12 is installed in the battery compartment 15. If a severe deviation from the parameters stored in the registers of the electronic processor 24 is detected and the battery pack 12 is not connected to the medical device 14, then the electronic processor 24 sends a signal to a fuse 28 to disable the battery pack 12 and prevent a failure.

The battery pack 12 further includes at least one fault detection sensor. In one embodiment, the at least one fault detection sensor includes a shock sensor 30 configured to measure or detect a fault comprising an impact to the battery pack 12. The shock sensor 30 can be any suitable sensor (e.g., a SQ-ASx sensor available from SignalQuest, Lebanon, N.H.). The shock sensor may be designed to detect an impact in one direction or in multiple directions. In the case of a unidirectional shock sensor, it is contemplated to provide two or three unidirectional shock sensors arranged to detect shocks in different directions, thereby enabling the electronic processor 24 to determine of the orientation of the shock based on which shock sensor(s) are triggered. As shown in FIG. 1, the (illustrative single) shock sensor 30 is a passive normally open shock sensor that includes at least one spring contact 32 configured to vibrate to make electrical contact generating one or more electric current pulses upon an impact to the battery pack 12 (and hence indirect impact to the plurality of battery cells 18 contained in the battery pack 12). More specifically, the shock sensor 30 includes a plurality of spring contacts 32 with each spring contact having different stiffness levels. Each spring contact 32 is normally open, that is, does not make contact to conduct an electrical current in the absence of an impact. The spring contact 32 is activated by an impact that is large enough to vibrate the spring to make contact and thereby conduct an electrical current. Optionally, the normally open shock sensor 30 includes debouncing (e.g. using frequency filtering, Schmitt trigger, an SR flip flop or so forth) to prevent rapid current oscillations in response to impact vibration. The electronic processor 24 is programmed to determine a magnitude of the impact depending on which of the spring contact(s) 30 is/are triggered. The stiffness levels can be selected according to any suitable standard (e.g., UN/DOT 38.3, IEC 62133-2 and/or MIL-STD-810E). The normally open shock sensor 30 does not conduct an electrical current (and hence does not consume any electrical power) unless a shock exceeding the stiffness of the spring contacts 32 is detected. Hence, the use of a normally open shock sensor operates to prevent additional current draw from the battery cells 18 while in shipment and storage.

In some embodiments, the shock sensor 30 is operatively connected with an accelerometer 34 configured to measure movement of the battery pack 12. In this arrangement, the normally open spring contact(s) 32 are connected with a “wake-up” pin (or interrupt pin or other similarly named input) of the accelerometer 34 to activate the accelerometer 34 to measure a magnitude of the impact on the plurality of battery cells 16. The accelerometer 34 is in sleep mode or some other low power mode unless/until the spring contact(s) 32 trigger the wake-up pin (or interrupt pin, etc.) to activate an accelerometer measurement, again ensuring minimal power drain on the battery cell(s) 18 during shipping and storage. The accelerometer 34 can be any suitable accelerometer (e.g., for example, a 3-axis ADXL345 accelerometer available from Analog Devices, Norwood, Mass.).

In other embodiments, the at least one fault detection sensor can additionally or alternatively include at least one gas sensor 36 configured to measure or detect a fault comprising a gas evolving from the plurality of battery cells 18. As shown in FIG. 1, the at least one gas sensor 36 is disposed adjacent at least one vent 38 of the housing 16. In some examples, the at least one gas sensor 36 includes a first gas sensor 36′ configured to measure hydrogen gas, and a second gas sensor 36″ configured to measure at least one of benzene, methane, and propylene (e.g., evolving from degrading polypropylene. In other examples, a single gas sensor 36 can be implemented to measure each of these gases. The first gas sensor 36′ can be, for example a SR-H04-SC device available from Honeywell, Morris Plains, N.J.), and the second gas sensor 36″ can be, for example, an MP7217 device available from SGX Sensortech, High Wycombe, UK).

The battery management system 20 optionally includes various other and/or alternative components. For example, the battery management system 20 may include at least one wireless transmitter or transceiver 44 (in addition to or in substitution for the data contacts of the set of contacts 23, 23′) to allow the battery management system to wirelessly transmit data measured by the at least one gas sensor 36 and/or the shock sensor 30, along with an identification (e.g., a serial number) of the battery pack. In other examples, the battery management system 20 also includes a temperature sensor 46 operatively connected with the at least one electronic processor 24 and configured to measure a temperature of the plurality of battery cells 18. A memory 48 is configured to store data measured by the temperature sensor 46, the at least one gas sensor 36, and/or the shock sensor 30. The memory 48 may be integral with the at least one electronic processor 24, or may be an ancillary component such as a separate non-volatile memory chip connected with the processor 24 via printed circuitry. The medical device 14 is configured to read the data stored in the memory 48 when the battery pack 12 is connected with the medical device. The housing 16 encloses the battery cells 18 and the components of the battery management system 20 (e.g., the at least one electronic processor 24, the shock sensor 30, the accelerometer 34, and the gas sensor(s) 36). The battery pack 12 can also include a display 50 to display visual messages and a loudspeaker 52 to output audio messages related to operation of the battery pack.

The battery management system 20 is configured to perform a remediation action responsive to detection of a fault by the shock sensor 30 and/or the gas sensor (s) 36. In some embodiments, when the fault detection sensor includes the shock sensor 30, the remediation action performed by the battery management system 20 responsive to detection of an impact by the shock sensor 30 can, for example, include (i) shutting off the plurality of battery cells 18 when the impact thereon exceeds a predetermined impact threshold (e.g., via triggering the fuse 28); (ii) storing an occurrence of the impact in the memory 48 when the impact on the plurality of battery cells is below the predetermined impact threshold; and/or (iii) generating a visual or audio message indicating that the plurality of battery cells needs to be replaced; and generating a visual or audio message (via a corresponding one of the display 50 or the loudspeaker 52) indicating that the medical device 14 should be replaced with a new medical device, among others. In other embodiments, when the fault detection sensor includes the gas sensor(s) 36, the remediation action performed by the battery management system 20 responsive to detection by the gas sensor(s) 36 of a gas evolving from the plurality of battery cells 16 includes triggering the fuse 28 or otherwise implementing an immediate shutdown of the battery pack when hydrogen or other gas is detected. Immediate shutdown is generally preferable in this case as detection of gas is likely indicative of incipient TRA, which is an urgent situation best remedied by battery shutdown. In the case of a class III medical device which provides life-critical service to a patient, the response to a gas detection may also include generating a visual or audio message on the medical device (e.g., powered by an emergency storage capacitor or the like) indicating that the battery pack needs to be immediately replaced.

The appropriate remediation for a given fault magnitude or sequence of fault detections is suitably empirically calibrated in the lab. For example, various test battery packs can be subjected to impacts of various magnitudes, and then accelerated aging applied to battery pack failure modes resulting from such impacts. Likewise, various test battery packs can be subjected to various sequences of impacts to assess the resulting failure modes.

For calibrating the gas sensor(s) 36, the background sensor signal in the environment inside the housing 16 is suitably measured to determine a fault detection threshold that is high enough to avoid false detection of faults; and likewise the gas sensor signal when gas is evolving due to incipient failure of a battery cell is determined empirically by subjecting test battery packs to various failure modes. In some contemplated embodiments, the gas sensor(s) 36 in conjunction with suitable signal processing performed by the microprocessor 24 detect a fault based on a rate of change of the gas sensor signal, as it is expected that an incipient battery cell failure is likely to produce a rapid increase in evolved gas concentration.

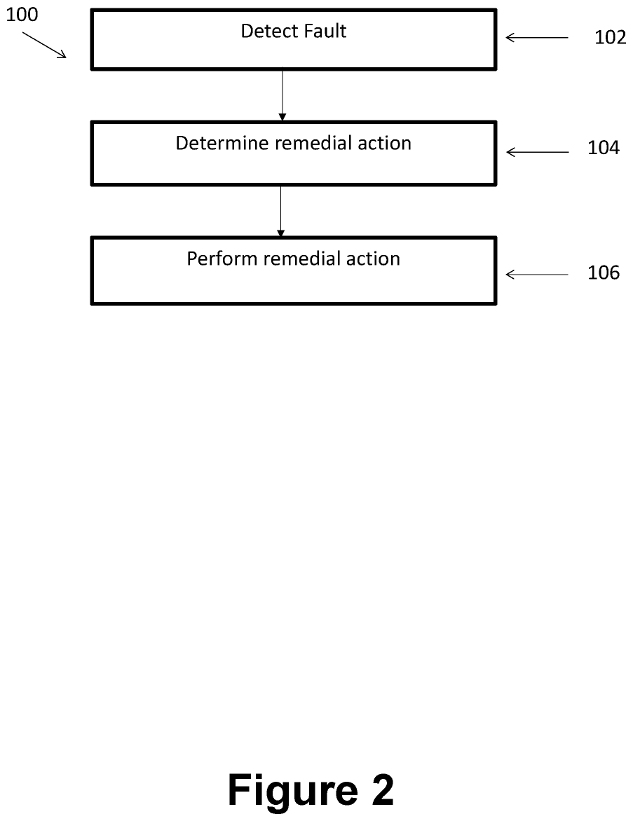

With reference to FIG. 2, an illustrative embodiment of a fault detection and remediation method 100 is diagrammatically shown as a flowchart. At 102 a fault is detected. At 104, a remedial action is determined. At 106, the remedial action is performed. The remediation action can include at least one of: shutting off the plurality of battery cells (18) when the impact thereon exceeds a predetermined impact threshold; storing an occurrence of the impact in a memory (48) when the impact on the plurality of battery cells is below the predetermined impact threshold; generating a visual or audio message indicating that the plurality of battery cells needs to be replaced; and generating a visual or audio message indicating that a medical device (14) powered by the battery pack should be replaced with a new medical device.

The disclosure has been described with reference to the preferred embodiments. Modifications and alterations may occur to others upon reading and understanding the preceding detailed description. It is intended that the disclosure be construed as including all such modifications and alterations insofar as they come within the scope of the appended claims or the equivalents thereof.

1. A battery pack, comprising:
one or more electrical battery cells;
a battery management system including at least one electronic processor configured to monitor parameters of the battery pack;
at least one fault detection sensor including at least one of:
at least one gas sensor configured to measure a gas evolving from the plurality of electrical battery cells; and
a shock sensor configured to measure an impact on the battery pack; and
a housing enclosing the plurality of electrical battery cells, the battery management system, and the at least one fault detection sensor;
wherein the battery management system is configured to perform a remediation action responsive to detection of a fault by the at least one fault detection sensor.

2. The battery pack of claim 1, wherein the at least one fault detection sensor includes a shock sensor configured to detect a fault comprising an impact to the battery pack.

3. The battery pack of claim 2, wherein the remediation action performed by the battery management system responsive to detection of an impact by the shock sensor includes at least one of:
shutting off the plurality of battery cells when the impact thereon exceeds a predetermined impact threshold;
storing an occurrence of the impact in a memory when the impact on the plurality of battery cells is below the predetermined impact threshold;
generating a visual or audio message indicating that the plurality of battery cells needs to be replaced; and
generating a visual or audio message indicating that a medical device powered by the battery pack should be replaced with a new medical device.

4. The battery pack of claim 2, wherein the shock sensor is a passive shock sensor comprising at least one spring contact configured to vibrate to generate one or more electric current pulses in response to an impact to the plurality of battery cells.

5. The battery pack of claim 4, wherein the passive shock sensor includes a plurality of spring contacts having different stiffness levels, and
the at least one electronic processor is programmed to determine a magnitude of the impact to the plurality of battery cells depending on which of the spring contact or contacts are triggered.

6. The battery pack claim 4, further including an accelerometer operatively connected with the shock sensor, the shock sensor configured to activate the accelerometer to measure a magnitude of the impact on the plurality of battery cells.

7. The battery pack of claim 1, wherein the at least one fault detection sensor includes at least one gas sensor configured to detect a fault comprising a gas evolving from the plurality of battery cells.

8. The battery pack of claim 7, wherein the at least one gas sensor includes:
a first gas sensor configured to measure hydrogen gas; and
a second gas sensor configured to measure at least one of hydrogen gas, benzene, methane, and propylene.

9. The battery pack of claim 7, wherein the remediation action performed by the battery management system responsive to detection by the at least one gas sensor of a gas evolving from the plurality of battery cells includes shutting off the plurality of battery cells.

10. The battery pack of claim 7, wherein the housing includes at least one vent and the at least one gas sensor is disposed adjacent the at least one vent.

11. The battery pack of claim 1, wherein the battery management system includes at least one wireless transmitter or transceiver and the battery management system is programmed to wirelessly transmit:
data measured by the at least one fault detection sensor; and
an identification of the battery pack.

12. The battery pack of claim 1, wherein the battery management system further includes:
a temperature sensor operatively connected with the battery management system and configured to measure a temperature of the plurality of battery cells, the housing further enclosing the temperature sensor; and
a memory configured to store data measured by at least one of the temperature sensor and by the at least one fault detection sensor.

13. An apparatus comprising:
a medical device; and
a battery pack as set forth in claim 12 connected with the medical device to electrically power the medical device;
wherein the medical device is configured to read the data stored in the memory when the battery pack is connected with the medical device.

14. A battery pack, comprising:
a plurality of electrical battery cells;
a battery management system including at least one electronic processor configured to monitor parameters of the plurality of battery cells;
a shock sensor configured to detect a fault comprising an impact to the battery pack; and
a housing enclosing the plurality of electrical battery cells, the battery management system, and the shock sensor;
wherein the battery management system is configured to perform a remediation action responsive to detection of a fault by the shock sensor.

15. The battery pack of claim 14, wherein the remediation action performed by the battery management system responsive to detection of an impact by the shock sensor includes at least one of:
shutting off the plurality of battery cells when the impact thereon exceeds a predetermined impact threshold;
storing an occurrence of the impact in a memory when the impact on the plurality of battery cells is below the predetermined impact threshold;
generating a visual or audio message indicating that the plurality of battery cells needs to be replaced; and
generating a visual or audio message indicating that a medical device powered by the battery pack should be replaced with a new medical device.

16. The battery pack of claim 14, wherein:
the shock sensor is a passive shock sensor comprising a plurality of spring contacts having different stiffness levels and configured to vibrate to generate one or more electric current pulses upon an impact to the plurality of battery cells; and
the at least one electronic processor is programmed to determine a magnitude of the impact to the plurality of battery cells depending on which of the spring contact or contacts are triggered.

17. The battery pack of either claim 16, further including an accelerometer operatively connected with the shock sensor, the shock sensor configured to activate the accelerometer to measure a magnitude of the impact on the plurality of battery cells.

18. A battery pack, comprising:
a plurality of electrical battery cells;
a battery management system including at least one electronic processor configured to monitor parameters of the plurality of battery cells;
at least one gas sensor configured to detect a fault comprising a gas evolving from the plurality of battery cells;
a housing enclosing the plurality of electrical battery cells, the battery management system, and the at least one gas sensor;
wherein the battery management system is configured to perform a remediation action responsive to detection of a fault by the at least one gas sensor.

19. The battery pack of claim 18, wherein the at least one gas sensor includes:
a first gas sensor configured to measure hydrogen gas; and
a second gas sensor configured to measure at least one of hydrogen gas, benzene, methane, and propylene.

20. The battery pack of claim 18, wherein the remediation action performed by the battery management system responsive to detection by the at least one gas sensor of a gas evolving from the plurality of battery cells includes shutting off the plurality of battery cells.
